(19) United States
(12) Patent Application Publication
(10) Pub. No.: US 2025/0199173 A1
(43) Pub. Date: Jun. 19, 2025

(54) DUAL-FREQUENCY FISH FINDER, AND DUAL-FREQUENCY TRANSMISSION METHOD

(71) Applicant: Furuno Electric Co., Ltd., Nishinomiya (JP)

(72) Inventors: Keita TAKARIKI, Nishinomiya (JP); Daisuke NISHIKUBO, Takarazuka (JP); Masahiko MAEDA, Itami (JP)

(21) Appl. No.: 19/072,718

(22) Filed: Mar. 6, 2025

Related U.S. Application Data
(63) Continuation of application No. PCT/JP2023/032722, filed on Sep. 7, 2023.

(30) Foreign Application Priority Data
Sep. 7, 2022 (JP) 2022-142109

(51) Int. Cl. G01S 15/96; G01S 7/524; G01S 7/527; G01S 7/539; G01S 7/56; G01S 15/89

(52) U.S. Cl. CPC G01S 15/96; G01S 7/524; G01S 7/5273; G01S 7/539; G01S 7/56; G01S 15/89

(57) ABSTRACT

The purpose is to provide a dual-frequency fish finder, a dual-frequency transmission method, and a program capable of suppressing noise based on interference waves of other frequencies in an echo image of each frequency when transmission waves of two frequencies are transmitted. A dual-frequency fish finder includes a processing circuitry. The processing circuitry is configured to transmit a first frequency signal during a reception period of the second frequency signal in a second transmission cycle between a transmission timing of the second frequency signal and an ending timing of a reception period of the first frequency signal, and to transmit the second frequency signal, having a different frequency from the first frequency signal, during a reception period of the first frequency signal in a first transmission cycle between a transmission timing of the first frequency signal and an ending timing of a reception period of the second frequency signal.

### CROSS-REFERENCE TO RELATED APPLICATION

This application is a continuation application of PCT International Application No. PCT/JP2023/032722, which was filed on Sep. 7, 2023, and which claims priority to Japanese Patent Application No. JP2022-142109 filed on Sep. 7, 2022, the entire disclosures of each of which are herein incorporated by reference for all purposes.

### TECHNICAL FIELD

The present disclosure relates to a dual-frequency fish finder for detecting a fish school in water, and a method for transmitting a dual-frequency transmission wave in water.

### BACKGROUND

Conventionally, a fish finder for detecting the fish school in water is known. In this type of fish finder, ultrasonic waves (transmission waves) are transmitted into the water from a transducer, and the reflected waves are received by the transducer. Echo data corresponding to the intensity of the received reflected wave is generated, and an echo image is displayed based on the generated echo data. In the echo image, the intensity (echo intensity) of the reflected wave of each water depth is displayed in a color of a corresponding gradation. The user can confirm the fish school present below the ship by referring to the echo image.

However, an unnecessary interference wave such as an ultrasonic wave transmitted from another device may be received by a transducer. In this case, noise based on the interference wave is reflected in the echo image.

Such noise is typically less likely to occur continuously at the same depth. Therefore, when the echo image is scanned in the time axis direction, if the echo intensity changes to a predetermined threshold value or more, it can be estimated that the echo intensity at the scanning position is based on the interference wave. Therefore, noise based on the interference wave can be removed from the echo image by reducing the estimated echo intensity to the lowest gradation.

### SUMMARY

An object of the present disclosure is to provide a dual-frequency fish finder, and a dual-frequency transmission method capable of more effectively suppressing noise based on interference waves of other frequencies in an echo image of each frequency when transmission waves of two frequencies are transmitted.

A first aspect of the present disclosure relates to a dual-frequency fish finder. A dual-frequency fish finder according to this aspect comprises a processing circuitry. The processing circuitry is configured to transmit a first frequency signal during a reception period of the second frequency signal in a second transmission cycle between a transmission timing of the second frequency signal and an ending timing of a reception period of the first frequency signal, and to transmit the second frequency signal, having a different frequency from the first frequency signal, during a reception period of the first frequency signal in a first transmission cycle between a transmission timing of the first frequency signal and an ending timing of a reception period of the second frequency signal.

According to the dual-frequency fish finder of the present aspect, it is possible to prevent echo intensities of interference waves of respective frequencies from being temporally adjacent to each other in a coordinate region in which depth and time are two axes. Therefore, the echo intensity due to the interference wave can be smoothly removed from the coordinate region by the above-described processing. Therefore, it is possible to suppress noise based on interference waves of other frequencies from being included in an echo image of each frequency.

A second aspect of the disclosure relates to a dual-frequency transmission method. The dual-frequency transmission method according to this aspect comprises transmitting a first frequency signal during a reception period of the second frequency signal in a second transmission cycle between a transmission timing of the second frequency signal and an ending timing of a reception period of the first frequency signal, and transmitting the second frequency signal, having a different frequency from the first frequency signal, during a reception period of the first frequency signal in a first transmission cycle between a transmission timing of the first frequency signal and an ending timing of a reception period of the second frequency signal.

According to the second aspect, effects similar to those of the first aspect can be achieved.

As described above, according to the present disclosure, it is possible to provide a dual-frequency fish finder, and a dual-frequency transmission method capable of suppressing noise based on an interference wave of another frequency in an echo image of each frequency when transmission waves of two frequencies are transmitted.

The effects and significance of the present disclosure will become more apparent from the following description of embodiments. However, the embodiment described below is merely an example for implementing the present disclosure, and the present disclosure is not limited to the embodiment described below.

### BRIEF DESCRIPTION OF DRAWINGS

FIG. 1 shows a diagram illustrating a use form of a fish finder according to an embodiment;

FIG. 2 shows a block diagram illustrating a configuration of a fish finder according to an embodiment;

FIG. 3 shows a flowchart illustrating an echo image generation process according to the embodiment;

FIG. 4 shows a diagram schematically illustrating a transmission method of transmission waves of a first frequency and a second frequency according to Comparative Example 1;

FIG. 5 shows a diagram schematically illustrating an appearance state of an interference echo (echo intensity) of a second frequency in a coordinate region of a first frequency according to Comparative Example 1;

FIG. 6 shows a diagram schematically illustrating a transmission method of transmission waves of a first frequency and a second frequency according to Comparative Example 2;

FIG. 7A shows a diagram schematically illustrating an appearance state of an interference echo (echo intensity) of a second frequency in a coordinate region of the first frequency according to Comparative Example 2. FIG. 7B shows a diagram schematically illustrating an appearance state of the interference echo (echo intensity) of the direct interference wave and the multiple reflection interference wave of the second frequency in the coordinate region of the first frequency according to Comparative Example 2;

FIG. 8 shows a diagram schematically illustrating a transmission method of transmission waves of a first frequency and a second frequency according to an embodiment;

FIG. 9A shows a diagram schematically illustrating an appearance state of an interference echo (echo intensity) of a direct interference wave and a multiple reflection interference wave of a second frequency in a coordinate region of the first frequency according to the embodiment. FIG. 9B shows a diagram schematically illustrating an appearance state of the interference echo (echo intensity) of the direct interference wave and the multiple reflection interference wave of the first frequency in the coordinate region of the second frequency according to the embodiment;

FIG. 10A shows diagram illustrating verification result of echo image based on the transmission wave of the first frequency (high frequency) displayed on the display unit when the transmission method of Comparative Example 2 is used. FIG. 10B shows diagram illustrating verification result of echo image based on the transmission wave of the second frequency (low frequency) displayed on the display unit when the transmission method of Comparative Example 2 is used;

FIG. 11A shows diagram illustrating verification result of echo image based on the transmission wave of the first frequency (high frequency) displayed on the display unit when the transmission method of the embodiment is used. FIG. 11B shows diagram illustrating verification result of echo image based on the transmission wave of the second frequency (low frequency) displayed on the display unit when the transmission method of the embodiment is used;

FIG. 12 shows a diagram schematically illustrating a transmission method of transmission waves of a first frequency and a second frequency according to Modified Example 1; and

FIG. 13 shows a diagram schematically illustrating a transmission method of transmission waves of a first frequency and a second frequency according to Modified Example 2.

### DETAILED DESCRIPTION

Embodiments of the present disclosure will now be described more fully hereinafter with reference to the accompanying drawings, in which exemplary embodiments of the disclosure are shown.

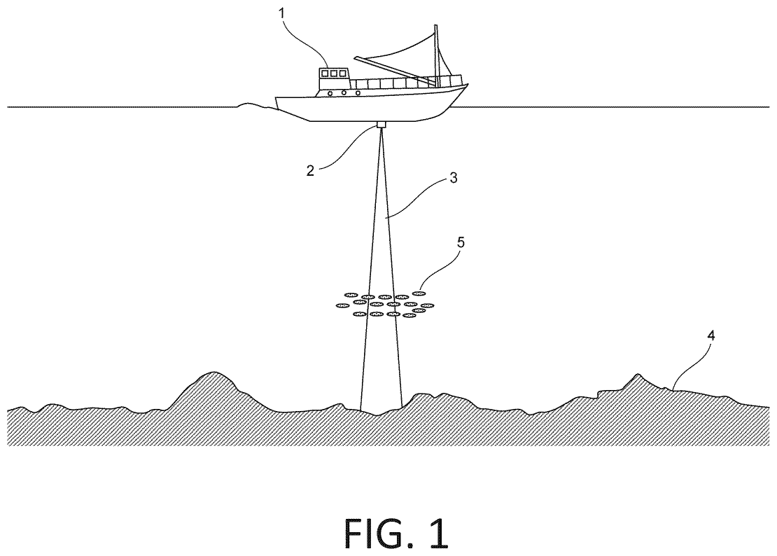

FIG. 1 is a diagram illustrating a use form of a fish finder according to an embodiment.

In the present embodiment, a transducer 2 is installed on the bottom of a ship 1, and a transmission wave 3 (ultrasonic wave) is transmitted underwater from the transducer 2. The transmission wave 3 has a conical shape with a small apex angle and is transmitted in a pulsed manner in a vertically downward direction. The transmission wave 3 is reflected by the bottom 4 or the school of fish 5, and the reflected wave (echo) is received by the transducer 2. The echo data in which the signal intensity (echo intensity) of the reception signal is distributed in the depth direction is generated by the reception signal of the reflection wave based on the transmission of one transmission wave 3.

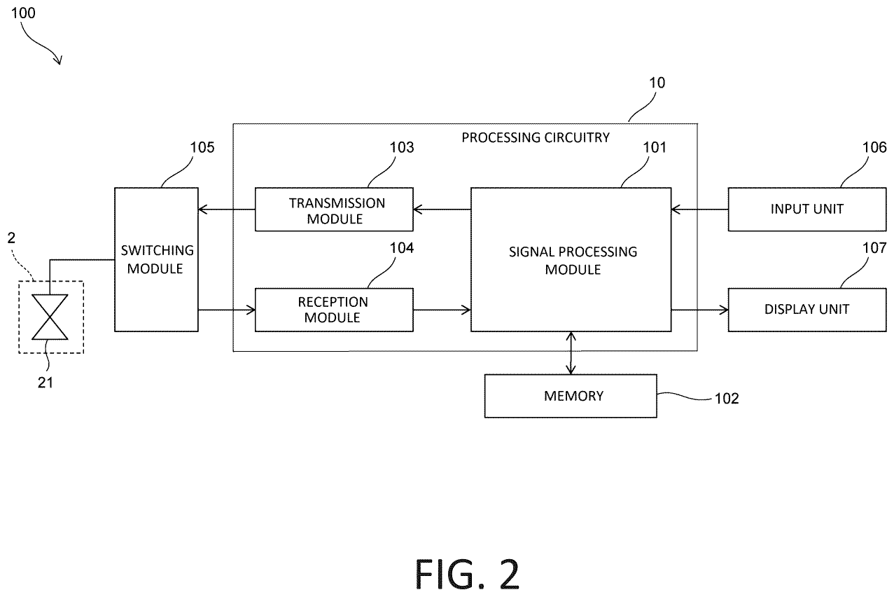

An echo image indicating a distribution of signal intensity (echo intensity) in a depth direction is generated by accumulating echo data for a predetermined time. The echo image includes the intensity distribution of the target. The generated underwater echo image is displayed on a display unit such as a monitor installed in a steering room or the like of the ship 1. Accordingly, the user can confirm the target (the bottom 4, the school of fish 5, or the like) present in the water. FIG. 2 is a block diagram illustrating a configuration of a fish finder 100.

The fish finder 100 includes, in addition to the transducer 2 shown in FIG. 1, a processing circuitry 10, a memory 102, a switching module 105, an input unit 106, and a display unit 107. The processing circuitry 10 includes a signal processing module 101, a transmission module 103, and a reception module 104. The fish finder 100 is a dual-frequency fish finder capable of transmitting two different frequency signals.

The signal processing module 101, the memory 102, the transmission module 103, the reception module 104, the switching module 105, the input unit 106, and the display unit 107 are installed in a steering room or the like of the ship 1. The configuration excluding the transducer 2 may be unitized in one housing, or some components such as the display unit 107 may be separated. The switching module 105 is communicably connected to the transducer 2 by a signal cable.

The transducer 2 includes a transmitter used for transmitting ultrasonic waves and a receiver used for receiving ultrasonic waves. In the present embodiment, the transmitter and the receiver of the transducer 2 are constituted by one ultrasonic transducer 21.

The transmission module 103 outputs a transmission signal of a predetermined frequency to the ultrasonic transducer 21 of the transducer 2 via the switching module 105 under the control of the signal processing module 101. The ultrasonic transducer 21 transmits an ultrasonic wave (transmission wave 3) into the water based on the transmission signal. The ultrasonic transducer 21 receives a reflected wave of the transmitted ultrasonic wave and outputs a reception signal having a magnitude corresponding to the intensity of the reflected wave to the reception module 104 via the switching module 105. The switching module 105 switches transmission and reception of signals to and from the ultrasonic transducer 21.

The reception module 104 generates echo data indicating an echo intensity for each depth based on a reception signal from the ultrasonic transducer 21. Specifically, the reception module 104 generates, as echo data, data in which an elapsed time from a timing at which the ultrasonic wave (transmission wave 3) is transmitted is associated with the intensity of the reflected wave, and outputs the generated echo data to the signal processing module 101. Here, the elapsed time from the timing at which the ultrasonic wave is transmitted corresponds to the depth.

The intensity of the reflected wave attenuates as the depth increases. Therefore, the reception module 104 corrects the intensity of the reflected wave that attenuates according to the elapsed time and outputs the echo data with the corrected intensity to the signal processing module 101 in order to be able to quantitatively handle the echo data regardless of the difference in depth. This correction process may be performed by the signal processing module 101 instead of the reception module 104.

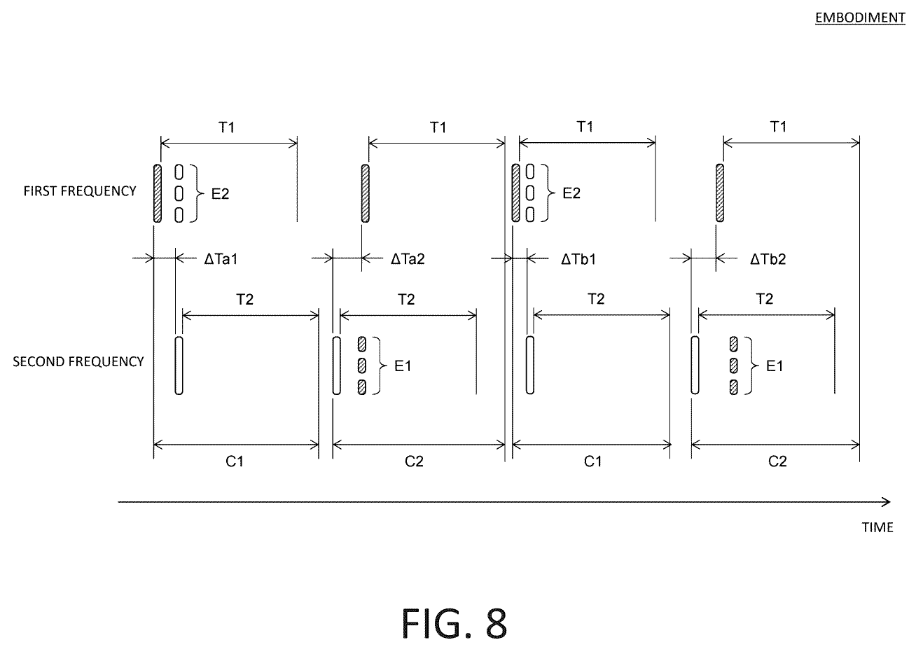

The signal processing module 101 includes an arithmetic processing circuit such as a CPU and an integrated circuit such as an FPGA. The memory 102 includes a ROM, a RAM, a hard disk, and the like. The memory 102 stores various programs. These programs include a program that causes the signal processing module 101 (computer) to execute a function of transmitting a transmission wave underwater and a function of processing echo data to generate an image. The memory 102 is used as a work area when the signal processing module 101 performs processing. The signal processing module 101 controls each unit by a program stored in the memory 102. The process of transmitting the transmission wave underwater will be described later with reference to FIG. 8.

The input unit 106 includes an input unit such as a mouse or a keyboard, and receives an input from a user. The input unit 106 may be a touch panel integrated with the display unit 107. The display unit 107 includes a display device such as a CRT monitor or a liquid crystal panel, and displays an image generated by the signal processing module 101. As will be described later, an echo image generated based on the echo data is displayed on the display unit 107.

The signal processing module 101 acquires echo data in which a depth and an echo intensity are associated with each other for each transmission (each ping) of an ultrasonic wave (transmission wave 3). The signal processing module 101 generates an echo image based on echo data of 1 frame (a plurality of pings) continuously acquired, and causes the display unit 107 to display the echo image. The echo image may be referred to as an echo diagram. The echo image is an image in which echo intensity is distributed in a coordinate region having two axes of depth and time. In the echo image, coloring or shading is applied to each pixel with a gradation corresponding to the intensity of the reflected wave (echo intensity). A user such as a fisherman can grasp the position and range of the school of fish in the water by referring to the echo image displayed on the display unit 107.

In the present embodiment, two types of transmission waves having different frequencies are transmitted from the transducer 2. That is, the signal processing module 101 causes the transmission module 103 to transmit the transmission wave of the first frequency and the transmission wave of the second frequency different from the first frequency. The first frequency is, for example, 200 kHz, and the second frequency is, for example, 50 kHz. The reflected wave of each frequency is received by the transducer 2. The transducer 2 outputs a reception signal on which each frequency is superimposed.

The reception module 104 includes filters for extracting the received signals of the first and second frequencies, respectively. The reception module 104 extracts signal components of the first frequency and the second frequency from the reception signal input from the switching module 105 and outputs the signal components to the signal processing module 101. The signal processing module 101 processes the extracted reception signal of each frequency to generate echo data for each frequency. In this way, by processing the reception signals for the two kinds of frequencies, for example, as described above, it is possible to more accurately perform the fish species determination or the like, or it is possible to determine whether or not the fish school is composed of a single fish species.

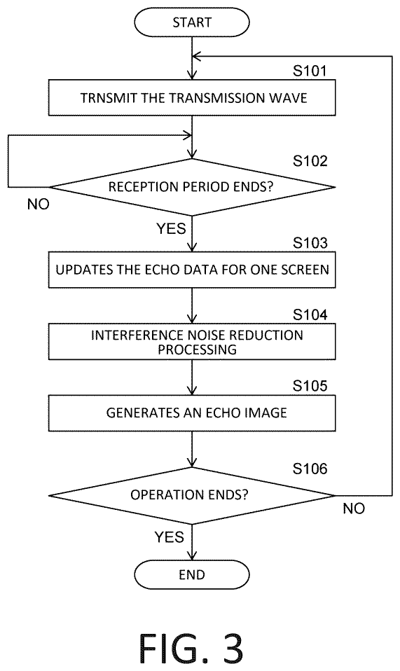

FIG. 3 is a flowchart illustrating an echo image generation process.

The signal processing module 101 performs the processing of FIG. 3 for each frequency. Here, for convenience, processing for the first frequency will be described.

The signal processing module 101 controls the transmission module 103 so that the transmission wave of the first frequency is transmitted from the transducer 2 (S101). In the reception period for the transmission, the reception module 104 sequentially outputs the reception signal of the first frequency to the signal processing module 101. When the reception period ends (YES in S102), the signal processing module 101 generates echo data from the input reception signal, stores the generated echo data in a memory area for one screen on the memory 102, and updates the echo data for one screen (S103).

That is, a memory area corresponding to a coordinate area having two axes of depth and time is set on the memory 102. The signal processing module 101 shifts the echo data stored in the memory area until the current processing by 1 unit in the direction of old time, and stores the echo data acquired this time in the latest time position. In this way, the signal processing module 101 updates the echo data for 1 screen.

The signal processing module 101 performs interference noise reduction processing on the updated echo data for one screen (S104). In the interference noise reduction processing, the updated echo data for one screen is scanned in the time axis direction at each depth position, and a scanning position at which the echo intensity changes to a predetermined threshold value or more is detected. Further, a range in which similar echo intensities continue for a predetermined length or more in the depth direction from the detected scanning position is detected. The range thus detected is estimated to be the range corresponding to the interference wave, and the echo intensity in this range is reduced to the echo intensity of the minimum gradation. Thus, the interference noise reduction process is completed.

The interference noise reduction processing may be performed on echo data for one column (latest echo data) newly added to the memory area and echo data for one column that is one unit older than the echo data, among echo data for one screen after update.

The signal processing module 101 generates an echo image from echo data for one screen subjected to the interference noise reduction processing (S105). When the mode in which the echo image based on the transmission wave of the first frequency is displayed on the display unit 107 is selected by the user, the signal processing module 101 newly displays the echo image generated in S105 on the display unit 107. As a result, the echo image displayed on the display unit 107 is updated.

The signal processing module 101 repeatedly executes the processing of S101 and the subsequent steps until the display operation of the echo image ends (NO in S106). As a result, the echo image is updated as needed and displayed on the display unit 107.

When the transmission waves of the first frequency and the second frequency are transmitted as described above, an interference wave based on the other transmission wave may be received in reception of one transmission wave. For example, after the transmission of the transmission wave of the first frequency (For example, high frequency) is performed first, when the transmission of the transmission wave of the second frequency (For example, low frequency) is performed in the reception period for the transmission, the interference wave of the transmission wave of the second frequency (the harmonic component of the direct wave reflected by the bubble or the like in the vicinity of the surface layer) is received by the transducer 2. In this case, if the interference wave is in the same frequency band as the first frequency, the interference wave is not removed by the filter for the first frequency in the reception module 104, and a signal based on the interference wave is superimposed on the reception signal. As a result, the echo intensity based on the interference wave is included in the echo data for one screen for the first frequency.

Similarly, after the transmission of the transmission wave of the second frequency (For example, low frequency) is performed first, when the transmission of the transmission wave of the first frequency (For example, high frequency) is performed in the reception period with respect to the transmission, the interference wave of the transmission wave of the first frequency (the frequency component 1/n times the frequency component of the direct wave) is received by the transducer 2. In this case, if the interference wave is in the same frequency band as the second frequency, the interference wave is not removed by the filter for the second frequency in the reception module 104, and a signal based on the interference wave is superimposed on the reception signal. As a result, the echo intensity based on the interference wave is included in the echo data for one screen for the second frequency.

Further, when the intensity of the interference wave is large enough to cause saturation in the reception module 104, the received signal has various frequency components. Also in this case, the same frequency component as the first frequency or the second frequency among these frequency components is not removed by the filter, and the echo intensity based on this frequency component is included in the echo data for one screen for the first frequency or the second frequency.

In this case, if the echoes based on the interference wave are not temporally adjacent to each other at the same depth, the echo intensity based on the interference wave can be removed from the echo data for 1 screen by the interference noise reduction processing in S104 of FIG. 3. However, if the echo intensities based on the interference waves are temporally adjacent to each other at the same depth, the echo intensities based on the interference waves cannot be removed by the interference noise reduction processing in S104 of FIG. 3.

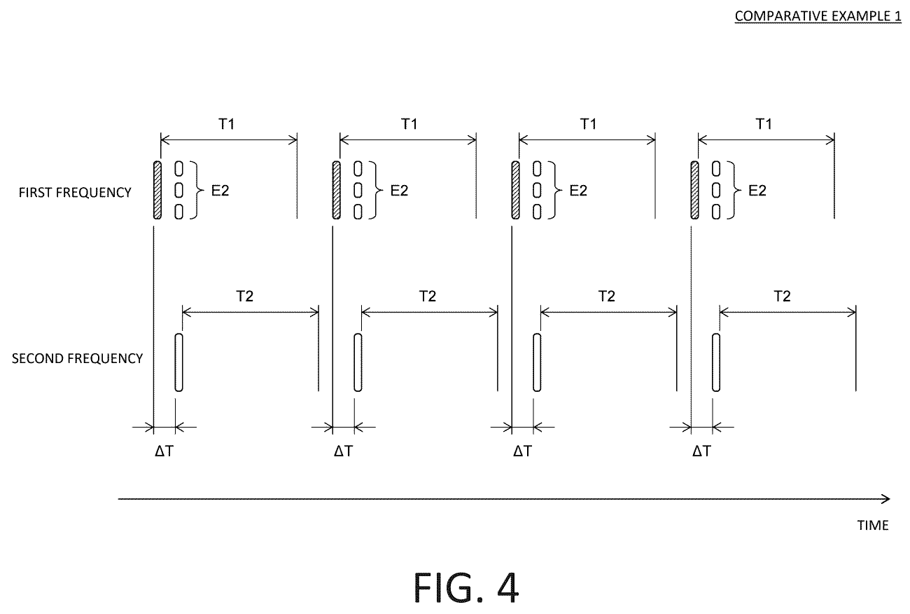

FIG. 4 is a diagram schematically illustrating a transmission method of transmission waves of a first frequency and a second frequency according to Comparative Example 1.

In FIG. 4, the transmission timing of the transmission wave of the first frequency is indicated by a hatched pseudo rectangle, and the transmission timing of the transmission wave of the second frequency is indicated by a white pseudo rectangle. In FIG. 4, the transmission of the transmission wave of the first frequency and the transmission of the transmission wave of the second frequency are performed four times. The same transmission cycle is repeated before and after the period shown in FIG. 4.

In Comparative Example 1, after the transmission of the transmission wave of the first frequency (For example, high frequency) is performed first, the transmission of the transmission wave of the second frequency (For example, low frequency) is performed in the reception period T1 for this transmission. In the reception period T2 of the transmission wave of the second frequency, the transmission of the transmission wave of the first frequency is not performed. The transmission cycle of the transmission waves of the first frequency and the second frequency is repeatedly performed. The interval ΔT between the transmission of the transmission wave of the first frequency and the transmission of the transmission wave of the second frequency is unchanged between the transmission cycles (both cycles are the same).

In the transmission method, since the transmission wave of the second frequency is transmitted in the reception period T1, as described above, the echo (interference echo E2) of the interference wave based on the transmission wave of the second frequency is received in the reception period T1. At this time, since the interval ΔT is constant, the timing at which the interference echo is received tends to be the same between the transmission cycles.

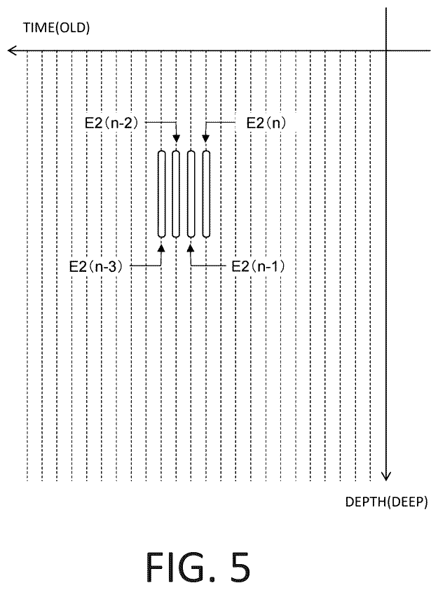

FIG. 5 is a diagram schematically illustrating an appearance state of an interference echo (echo intensity) of a second frequency in a coordinate region of a first frequency when the transmission method of Comparative Example 1 is applied.

FIG. 5 illustrates a state in which echo data is mapped to a coordinate region having depth and time as two axes. In FIG. 5, one broken line indicates echo data for one column of the first frequency in one transmission cycle. E2(k) indicates a depth range in which the echo intensity of the interference echo E2 of the second frequency is superimposed on the echo data of one column of the first frequency in the kth transmission cycle.

As described above, in the transmission cycle of FIG. 4, since the interval ΔT is the same between the transmission cycles, as illustrated in FIG. 5, the echo intensity of the interference echo E2 is likely to appear in the range of the same depth. Therefore, the echo intensities of the interference echoes E2 tend to be temporally adjacent to each other in the same depth range. On the other hand, in the interference noise reduction processing in S104 of FIG. 3, as described above, the echo data for 1 screen is scanned in the time axis direction at each depth position, and the scanning position at which the echo intensity changes to be equal to or greater than the predetermined threshold value is estimated as the position at which the interference echo exists. Therefore, when the echo intensities of the interference echoes E2 are adjacent to each other in the same depth range as illustrated in FIG. 5, the echo intensities of the interference echoes E2 cannot be removed from the echo data by the interference noise reduction processing.

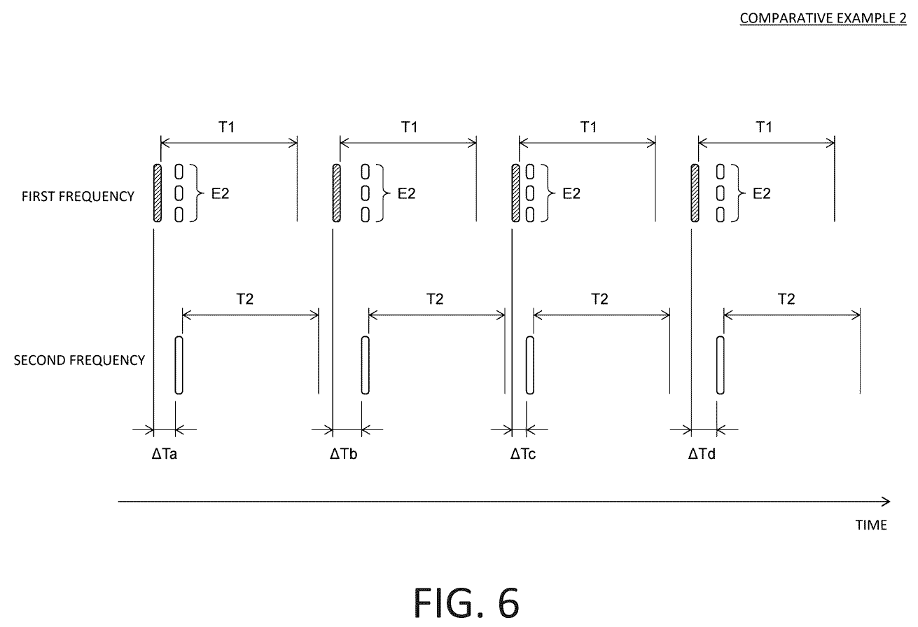

FIG. 6 is a diagram schematically illustrating a method of transmitting transmission waves of a first frequency and a second frequency according to Comparative Example 2.

In Comparative Example 2, the interval ΔT between the transmission of the transmission wave of the first frequency and the transmission of the transmission wave of the second frequency is set to be different between the latest transmission cycles. In the example of FIG. 6, intervals ΔTa, ΔTb, ΔTc, and ΔTd that are different from each other are set for four consecutive transmission cycles. The four intervals ΔTa, ΔTb, ΔTc, and ΔTd in FIG. 6 may be cyclically applied to the fifth and subsequent transmission cycles, or further different intervals may be applied.

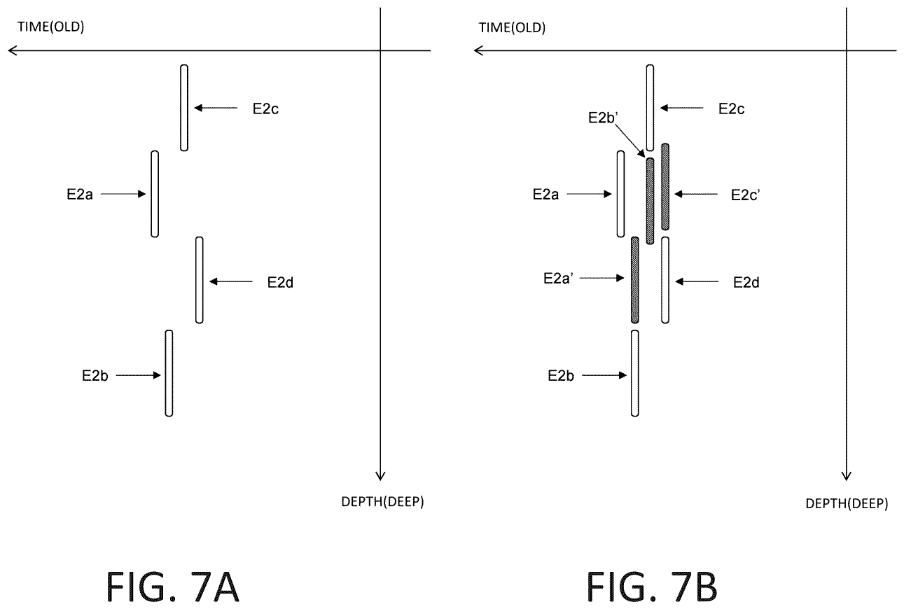

FIG. 7A is a diagram schematically illustrating an appearance state of an interference echo (echo intensity) of a second frequency in a coordinate region of a first frequency when the transmission method of Comparative Example 2 is applied.

Similar to FIG. 5, FIG. 7A illustrates a state in which echo data is mapped to a coordinate region having depth and time as two axes. For convenience, dashed lines indicating the echo data of each column are omitted in FIG. 7A. In FIG. 7A, E2a, E2b, E2c, and E2d indicate interference echoes of transmission waves of the second frequency transmitted at intervals ΔTa, ΔTb, ΔTc, and ΔTd in four consecutive transmission cycles, respectively.

In Comparative Example 2, as shown in FIG. 6, the intervals ΔTa, ΔTb, ΔTc, and ΔTd that are different from each other are set in the four successive transmission cycles, and therefore, as shown in FIG. 7A, the echo intensity of the interference echo E2 is likely to occur in the range of different depths. Therefore, these echo intensities are less likely to be adjacent to each other in the time axis direction as illustrated in FIG. 7A.

However, the interference wave of the second frequency includes not only the interference wave (Hereinafter, it is referred to as “direct interference wave”.) reflected by water bubbles or the like in the vicinity of the surface layer and received by the transducer 2, but also the interference wave (Hereinafter, it is referred to as a “multiple reflection interference wave”.) received by the transducer 2 after multiple reflection between the water bottom and the ship or between the water bottom and the water surface. Therefore, the echo intensity of the multiple reflection interference wave of the second frequency may further appear in the coordinate region of the first frequency.

FIG. 7B is a diagram schematically illustrating an appearance state of an interference echo (echo intensity) of a direct interference wave and a multiple reflection interference wave of a second frequency in a coordinate region of the first frequency in a case where the transmission method of Comparative Example 2 is applied.

In FIG. 7B, the interference echoes E2a′ to E2c′ of the multiple reflection interference wave by the transmission of the second frequencies of the first to third in FIG. 6 are shown together with the interference echoes E2a to E2d of the direct interference wave in FIG. 7A.

When the intervals ΔTa, ΔTb, ΔTc, and ΔTd, which are different from each other, are set in four consecutive transmission cycles as in the transmission cycle of Comparative Example 2, interference echoes E2a to E2d of direct interference waves are prevented from being temporally adjacent to each other as illustrated in FIG. 7A. However, in this case, as shown in FIG. 7B, the interference echoes E2a′ to E2c′ of the multiple reflection interference wave may be temporally adjacent to each other, and the interference echoes E2a to E2d of the direct interference wave and the interference echoes E2a′ to E2c′ of the multiple reflection interference wave may be temporally adjacent to each other. Therefore, even if the interval is made different between cycles as in Comparative Example 2, the echo intensity of the interference echo (Direct interference wave and multiple reflection interference wave) of the second frequency cannot be reliably removed from the echo data by the interference noise reduction processing.

In order to solve such a problem, in the present embodiment, a transmission method capable of more reliably removing the echo intensity of the interference echo due to the direct interference wave and the multiple reflection interference wave from the echo data of each frequency is used.

FIG. 8 is a diagram schematically illustrating a transmission method of transmission waves of a first frequency and a second frequency, which is performed by control of the signal processing module 101 with respect to the transmission module 103, according to the embodiment.

In the transmission method of the embodiment, transmission of the transmission wave of the respective frequencies is performed in a state that a first transmission cycle C1 for transmitting the transmission wave of the second frequency in a reception period T1 from transmission of the transmission wave of the first frequency to reception of the transmission wave of the first frequency, and a second transmission cycle C2 for transmitting the transmission wave of the first frequency in a reception period T2 from transmission of the transmission wave of the second frequency to reception of the transmission wave of the second frequency are arranged in a mixed manner on the time axis.

In the example of FIG. 8, the transmission waves of the respective frequencies are transmitted so that the first transmission cycle C1 and the second transmission cycle C2 are alternately arranged. After the transmission cycle of FIG. 8, the transmission of the transmission wave of each frequency is performed so that the first transmission cycle C1 and the second transmission cycle C2 are alternately arranged.

In addition, after the reception period of one transmission cycle ends, transmission of the next transmission cycle is performed. More specifically, after the reception period T2 of the first transmission cycle C1 ends, the transmission of the second transmission cycle C2 is performed, and after the reception period T1 of the second transmission cycle C2 ends, the transmission of the first transmission cycle C1 is performed.

Intervals ΔTa1, ΔTb1 between the transmission of the transmission wave of the first frequency and the transmission of the transmission wave of the second frequency in the first transmission cycle C1 are made different from each other in the immediately preceding first transmission cycle C1. Further, the intervals ΔTa2 and ΔTb2 between the transmission of the transmission wave of the second frequency and the transmission of the transmission wave of the first frequency in the second transmission cycle C2 are made different between the latest second transmission cycles C2.

In the transmission method of FIG. 8, since the transmission of the second frequency is performed in the reception period T1 of the first frequency in the first transmission cycle C1, the echo intensity of the interference echo of the second frequency is superimposed on the echo data of the first frequency, but the echo intensity of the interference echo of the first frequency is not superimposed on the echo data of the second frequency. In the second transmission cycle C2, since the transmission of the first frequency is performed in the reception period T2 of the second frequency, the echo intensity of the interference echo of the first frequency is superimposed on the echo data of the second frequency, but the echo intensity of the interference echo of the second frequency is not superimposed on the echo data of the first frequency.

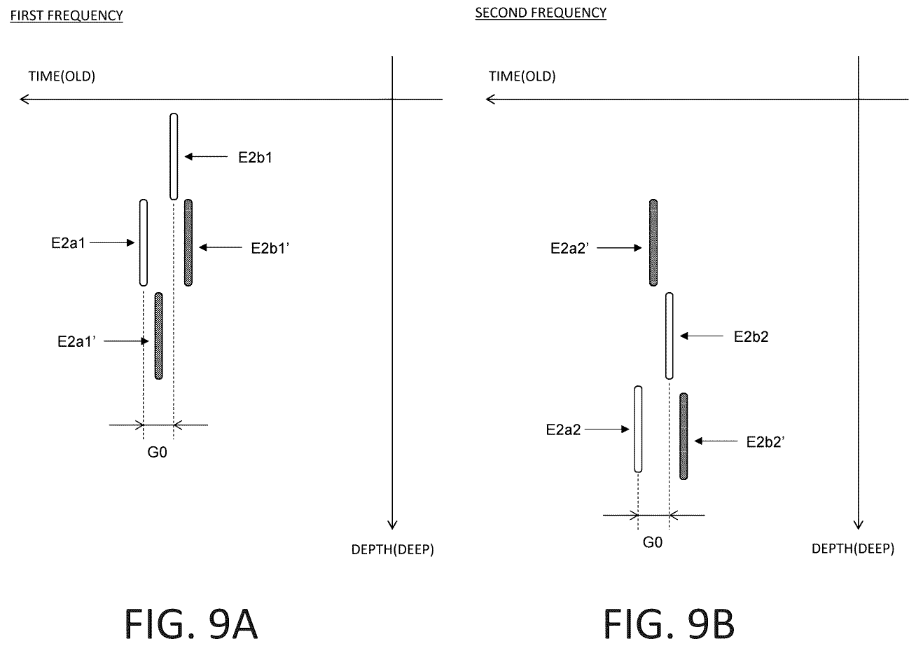

FIG. 9A is a diagram schematically illustrating an appearance state of an interference echo (echo intensity) of a direct interference wave and a multiple reflection interference wave of a second frequency in a coordinate region of the first frequency when the transmission method according to the embodiment is applied. FIG. 9B is a diagram schematically illustrating an appearance state of the interference echo (echo intensity) of the direct interference wave and the multiple reflection interference wave of the first frequency in the coordinate region of the second frequency when the transmission method according to the embodiment is applied.

Similar to FIG. 5, FIG. 9A and FIG. 9B illustrate a state in which echo data of a first frequency and echo data of a second frequency are mapped to coordinate regions having two axes of depth and time, respectively. For convenience, in FIG. 9A and FIG. 9B, dashed lines indicating the echo data of each column are omitted.

In FIG. 9A, E2al and E2b1 indicate a depth range in which the echo intensity of the direct interference wave of the second frequency in the first transmission cycles C1 of the first and third in FIG. 8 is superimposed on the echo data of the first frequency, and E2al′ and E2b1 ′ indicate a depth range in which the echo intensity of the multiple reflected interference wave of the second frequency in the first transmission cycles C1 of the first and third in FIG. 8 is superimposed on the echo data of the first frequency.

In FIG. 9B, E2a2 and E2b2 indicate a depth range in which the echo intensity of the direct interference wave of the first frequency in the second transmission cycles C2 of the second and fourth in FIG. 8 is superimposed on the echo data of the second frequency, and E2a2′ and E2b2′ indicate a depth range in which the echo intensity of the multiple reflected interference wave of the first frequency in the second transmission cycles C2 of the second and fourth in FIG. 8 is superimposed on the echo data of the second frequency.

In the transmission method of FIG. 8, since the second transmission cycle C2 exists between two adjacent first transmission cycles C1, the interference wave of the second frequency is generated in the reception period T1 of the first frequency every other transmission cycle. Therefore, as shown in FIG. 9A, the interference echoes E2al and E2b1 of the direct interference wave and the interference echoes E2al′ and E2b1 ′ of the multiple reflection interference wave of the second frequency appear in the coordinate region of the first frequency at the time interval GO of every cycle. Therefore, in the transmission method of FIG. 8, as compared with the transmission method of the Comparative Example 2 of FIG. 7B, the density of the interference echo is reduced by the amount of omission of the interference echo in the time interval GO, and the echo intensities of the interference echo are less likely to be temporally adjacent to each other. Accordingly, in the transmission method of FIG. 8, the echo intensity of the interference echo of the second frequency is easily removed from the echo data of the first frequency by the interference noise reduction processing of FIG. 3.

As shown in FIG. 9B, also in the echo data of the second frequency, the interference echoes E2a2 and E2b2 of the direct interference wave and the interference echoes E2a2′ and E2b2′ of the multiple reflection interference wave of the first frequency appear at the time interval GO of every transmission cycle. Therefore, the density of the interference echo of the first frequency in the coordinate region of the second frequency is the same as that in the case of the first frequency illustrated in FIG. 9A. Therefore, in the transmission method of FIG. 8, the echo intensity of the interference echo of the first frequency is easily removed from the echo data of the second frequency by the interference noise reduction processing of FIG. 3.

The intervals of the first transmission cycle C1 illustrated in FIG. 8 may be different from each other in a predetermined number of consecutive first cycles, and similar intervals may be cyclically repeated in the subsequent first cycles. Similarly, the intervals of the second transmission cycle C2 may be different from each other in a predetermined number of consecutive second cycles, and similar intervals may be cyclically repeated in the subsequent second cycles. The predetermined number and the length of each interval may be set to a number and a length that can appropriately suppress the echo intensities of the direct interference wave and the multiple reflection interference wave from being temporally adjacent to each other in the coordinate region of each frequency.

The inventors have experimentally confirmed how interference echoes are generated when the transmission method of Comparative Example 2 and the transmission method of the embodiment are used.

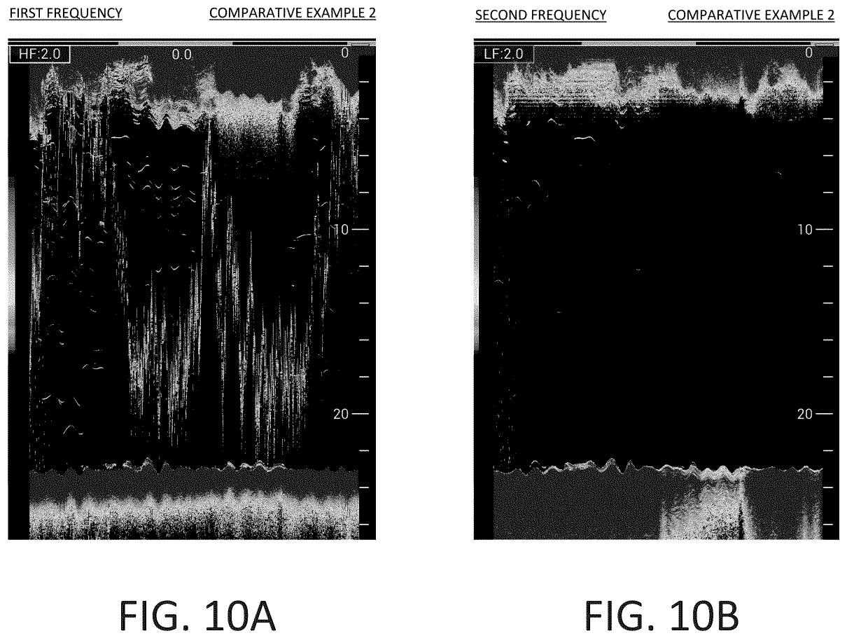

FIG. 10A and FIG. 10B are diagrams illustrating echo images displayed on the display unit 107 when the transmission method of Comparative Example 2 is used. FIG. 10A shows an echo image based on the transmission wave of the first frequency (high frequency), and FIG. 10B shows an echo image based on the transmission wave of the second frequency (low frequency).

As shown in FIG. 10B, in the transmission method of Comparative Example 2, noise based on the interference wave of the first frequency did not appear in the echo image of the second frequency. This is because, as illustrated in FIG. 6, since the transmission wave of the first frequency is not transmitted in the reception period T2 of the second frequency, the echo intensity of the interference wave (Direct interference wave and multiple reflection interference wave) of the first frequency is not superimposed on the echo data of the second frequency.

In contrast, as shown in FIG. 10A, in the transmission method of Comparative Example 2, noise based on the interference wave of the second frequency was considerably reflected in the echo image of the first frequency. This is because, as illustrated in FIG. 6, since the transmission wave of the second frequency is transmitted in all the reception periods T1 of the first frequency, the echo intensity of the interference wave (Direct interference wave and multiple reflection interference wave) of the second frequency is superimposed on the echo data of the first frequency for each reception period T1. That is, in this case, as described with reference to FIG. 7B, the echo intensities of these interference waves are less likely to be removed by the interference noise reduction processing (S104 in FIG. 3). Therefore, as shown in FIG. 10A, the noise based on the interference wave of the second frequency is considerably reflected in the echo image of the first frequency.

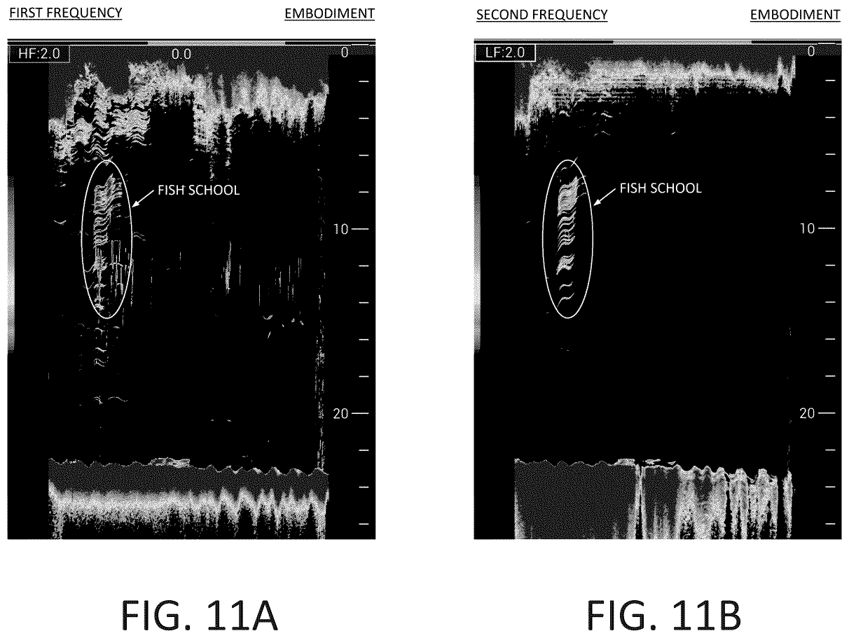

FIG. 11A and FIG. 11B are diagrams illustrating echo images displayed on the display unit 107 when the transmission method of the embodiment is used. FIG. 10A shows an echo image based on the transmission wave of the first frequency (high frequency), and FIG. 10B shows an echo image based on the transmission wave of the second frequency (low frequency).

As shown in FIG. 11B, in the transmission method of the embodiment, almost no noise based on the interference wave of the first frequency appears in the echo image of the second frequency. As shown in FIG. 11A, in the echo image of the first frequency, noise based on the interference wave of the second frequency was slightly reflected as compared with the echo image of the second frequency of FIG. 11B, but noise based on the interference wave of the second frequency was significantly suppressed as compared with the case of Comparative Example 2 shown in FIG. 10A. This is because, as described with reference to FIG. 9A and FIG. 9B, the density of the echo intensities of these interference waves decreased in the respective coordinate regions of the first frequency and the second frequency, and thus the echo intensities of these interference waves could be substantially removed by the interference noise reduction processing (S104 in FIG. 3).

As described above, according to the transmission method of the embodiment, it was confirmed that the influence of the interference wave of one frequency on the echo data of the other frequency can be more reliably suppressed. Accordingly, it was confirmed that noise based on interference waves of other frequencies can be reliably suppressed in an echo image of each frequency.

According to the present embodiment, the following effects are obtained.

As shown in FIG. 8, the signal processing module 101 controls the transmission module 103 so that a first transmission cycle C1 for transmitting a transmission wave of a second frequency different from the first frequency in a reception period T1 from transmission of the transmission wave of the first frequency to reception of the transmission wave of the first frequency and a second transmission cycle C2 for transmitting the transmission wave of the first frequency in a reception period T2 from transmission of the transmission wave of the second frequency to reception of the transmission wave of the second frequency are arranged in a mixed manner on the time axis. Accordingly, it is possible to prevent the echo intensities of the interference waves of the respective frequencies from being temporally adjacent to each other in the coordinate region in which the depth and the time are the two axes. Therefore, the echo intensity of these interference waves can be smoothly removed by the interference noise reduction processing (S104). Therefore, it is possible to suppress noise based on interference waves of other frequencies in an echo image of each frequency.

As shown in FIG. 8, the signal processing module 101 controls the transmission module 103 so that the first transmission cycle C1 and the second transmission cycle C2 are alternately arranged. As a result, since the echo intensity of the interference wave appears at a time interval of every transmission cycle in the coordinate region of each frequency, the echo intensity of the interference wave is less likely to be temporally adjacent in the coordinate region. Therefore, the echo intensity due to the interference wave can be smoothly removed by the interference noise reduction processing (S104). Therefore, as illustrated in FIG. 11A and FIG. 11B, it is possible to reliably remove the noise based on the interference wave from the echo image.

As shown in FIG. 8, the signal processing module 101 sets the transmission timing in each transmission cycle so that the transmission of the next transmission cycle is performed after the reception period of one transmission cycle ends. Accordingly, in the reception period of one transmission cycle, an interference wave due to transmission of the next transmission cycle does not occur. Therefore, it is possible to more reliably suppress the influence of the interference wave on the echo image.

As shown in FIG. 8, the signal processing module 101 makes the intervals ΔTa1 and ΔTb1 between the transmission of the transmission wave of the first frequency and the transmission of the transmission wave of the second frequency in the first transmission cycle C1 different from each other in the most recent first transmission cycle C1, and makes the intervals ΔTa2 and ΔTb2 between the transmission of the transmission wave of the second frequency and the transmission of the transmission wave of the first frequency in the second transmission cycle C2 different from each other in the most recent second transmission cycle C2. As a result, as illustrated in FIG. 9A and FIG. 9B, the echo intensities of the interference waves are less likely to overlap in the same depth range in the coordinate regions of the respective frequencies. Therefore, the echo intensity due to the interference wave can be smoothly removed by the interference noise reduction processing (S104). Therefore, it is possible to more reliably remove the noise based on the interference wave from the echo image.

As shown in FIG. 3, the signal processing module 101 executes, for each of the first frequency and the second frequency, the interference noise reduction processing (S103) of reducing the echo intensity based on the interference wave based on the echo intensity at the temporally adjacent coordinate position at the same depth when the echo intensity of the echo data is mapped to the coordinate region having the depth and the time as the two axes. Accordingly, as shown in FIG. 9A and FIG. 9B, when the interference echoes of the direct interference wave and the multiple reflection interference wave are generated at the time interval GO of every other cycle, the interference echoes can be smoothly removed by the interference noise reduction processing. Therefore, as illustrated in FIG. 11A and FIG. 11B, an echo image in which noise due to interference echo is suppressed can be generated.

As shown in FIG. 3, the signal processing module 101 generates an echo image based on the echo intensity for one screen of the first frequency and the second frequency to which the interference noise reduction processing (S104) is applied (S105). As a result, as illustrated in FIG. 11A and FIG. 11B, an echo image from which noise due to interference echoes has been removed can be generated.

Both of the echo images of the respective frequencies generated in S105 may not necessarily be displayed on the display unit 107. For example, only the echo image of the first frequency may be displayed on the display unit 107, and the echo image of the second frequency may be used to calculate the difference between the echo intensity of the first frequency and the echo intensity of the second frequency for the fish school. In addition, the user may be able to appropriately switch the frequency of the echo image to be displayed on the display unit 107.

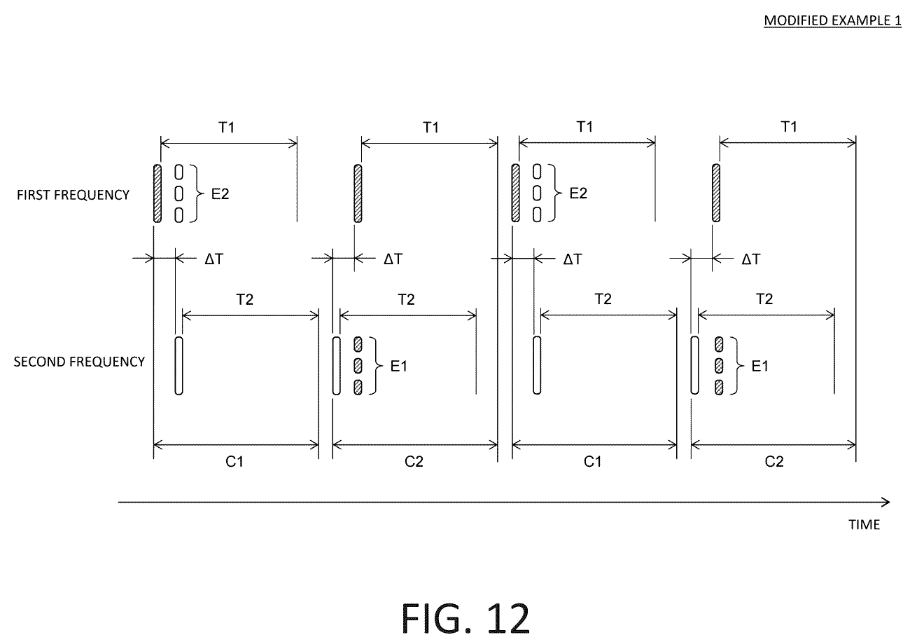

In the above embodiment, as shown in FIG. 8, the intervals ΔTa1 and ΔTb1 between the transmission of the transmission wave of the first frequency and the transmission of the transmission wave of the second frequency in the first transmission cycle C1 are different between the latest first transmission cycles C1, and the intervals ΔTa2 and ΔTb2 between the transmission of the transmission wave of the second frequency and the transmission of the transmission wave of the first frequency in the second transmission cycle C2 are different between the latest second transmission cycles C2. On the other hand, in the Modified Example 1, as shown in FIG. 12, these intervals ΔT are the same.

Also in the transmission method of the Modified Example 1, since the first transmission cycle C1 and the second transmission cycle C2 are alternately arranged, the echo intensities of the direct interference wave and the multiple reflection interference wave are superimposed on the coordinate region of each frequency at the time interval GO of every other cycle similarly to the above embodiment. Therefore, since the echo intensities of the interference waves are suppressed from being temporally adjacent to each other in these coordinate regions, the echo intensities of the interference waves are easily removed by the interference noise reduction processing. Therefore, it is possible to generate an echo image in which noise due to interference echo is suppressed.

Note that, as in the above-described embodiment, by making the intervals different from each other, it is possible to further suppress the echo intensities of the interference waves from being temporally adjacent to each other in the coordinate region of each frequency. Therefore, in order to more reliably remove the noise due to the interference echo from the echo image, it can be said that it is preferable to make the interval different between the latest first transmission cycles C1 and the interval different between the latest second transmission cycles C2 as in the above-described embodiment. Accordingly, it is possible to generate an echo image in which noise due to interference echo is further suppressed.

In the above embodiment, as shown in FIG. 8, the transmission module 103 is controlled so that the first transmission cycle C1 and the second transmission cycle C2 are alternately arranged. However, as long as the first transmission cycle C1 and the second transmission cycle C2 are arranged in a mixed manner on the time axis, the first transmission cycle C1 and the second transmission cycle C2 may be arranged in another method.

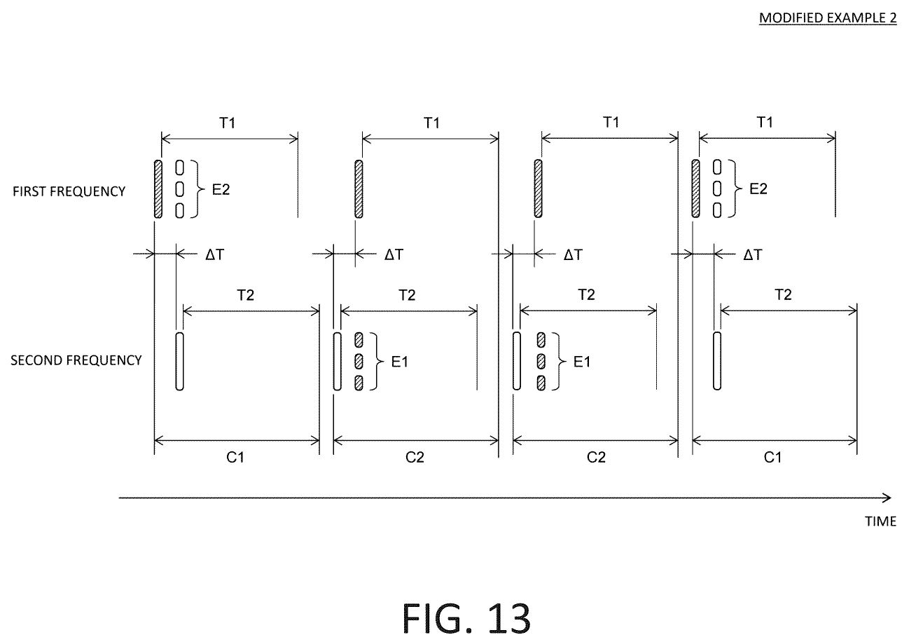

For example, as illustrated in FIG. 13, the transmission cycles may be arranged in the order of the first transmission cycle C1, the second transmission cycle C2, the second transmission cycle C2, and the first transmission cycle C1, and thereafter, the arrangement in this order may be cyclically repeated.

In the transmission method of FIG. 13, the time interval of the interference echo E2 of the second frequency generated in the reception period T1 of the first frequency may be a time interval corresponding to 3 transmission cycles or a time interval corresponding to 1 transmission cycle. Similarly, the time interval of the interference echo E1 of the first frequency occurring in the reception period T2 of the second frequency may be a time interval corresponding to three transmission cycles or a time interval corresponding to one transmission cycle.

Therefore, although the echo intensities of the interference echoes generated at the time intervals corresponding to one transmission cycle are more likely to be temporally adjacent to each other than in the case of the transmission method of the above embodiment, the echo intensities of the interference echoes generated at the time intervals corresponding to three transmission cycles are further less likely to be temporally adjacent to each other than in the case of the transmission method of the above embodiment. Therefore, at least the echo intensity of the interference echo generated at the time interval corresponding to the three transmission cycles is more likely to be removed by the interference noise reduction processing than in the case of the transmission method of the above embodiment.

The arrangement of the first transmission cycle C1 and the second transmission cycle C2 may be set to an arrangement capable of effectively removing noise due to interference waves of other frequencies from echo images of the first frequency and the second frequency. Accordingly, the quality of the echo image of each frequency can be improved.

The present disclosure is not limited to the above embodiment, and various modifications other than the above can be made to the embodiment of the present disclosure.

For example, in the above embodiment, the first frequency is a high frequency (200 kHz) and the second frequency is a low frequency (50 kHz), but the first frequency may be a low frequency and the second frequency may be a high frequency. The first frequency and the second frequency may not be 200 kHz and 50 kHz, and may be other frequencies. It is needless to say that this is also effective in the case of transmitting transmission waves of, for example, three or more kinds of frequencies including a third frequency different from the first frequency and the second frequency.

Further, in the above-described embodiment, an example in which the present disclosure is applied to the fish finder 100 mounted on the ship 1 is shown, but the application target of the present disclosure is not limited thereto. For example, the present disclosure may be applied to a fish finder installed in a stationary net. In this case, the transmission method shown in FIG. 8, FIG. 12, and FIG. 13 is performed in the fish finder. The fish finder transmits echo data obtained for the first frequency and the second frequency to a server on land, and the server on land transmits an echo image generated from the received echo data to a terminal of a user.

In this case, the interference noise reduction process in step S104 of FIG. 3 may be performed on the server side. In this case, the fish finder transmits the echo data obtained for the first frequency and the second frequency to the server as they are, and the server updates the echo data for one screen as needed with the received echo data, applies the interference noise reduction processing, and generates an echo image from the echo data for one screen after the application.

Alternatively, as in the above-described embodiment, the interference noise reduction process may be performed on the fish finder side. In this case, the fish finder transmits echo data for one screen after applying the interference noise reduction processing to the server at any time.

Further, the interference noise reduction process may not be the process described in the above embodiment, and an interference noise reduction process by another method may be applied as long as the echo intensity by the interference wave can be suppressed from the echo data for one screen obtained by the transmission method of the present embodiment.

In addition, the embodiments of the present disclosure can be modified in various ways as appropriate within the scope of the claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A dual-frequency fish finder capable of transmitting two different frequency signals, comprising:
processing circuitry configured to:
transmit a first frequency signal during a reception period of a second frequency signal in a second transmission cycle between a transmission timing of the second frequency signal and an end timing of a reception period of the first frequency signal; and
transmit the second frequency signal, having a different frequency from the first frequency signal, during a reception period of the first frequency signal in a first transmission cycle between a transmission timing of the first frequency signal and an end timing of a reception period of the second frequency signal.

2. The dual-frequency fish finder of claim 1, wherein:
processing circuitry is further configured to align the first transmission cycle and the second transmission cycle in a mixed manner.

3. The dual-frequency fish finder of claim 1, wherein:
the processing circuitry is further configured to align the first transmission cycle and the second transmission cycle alternately.

4. The dual-frequency fish finder of claim 1, wherein:
the processing circuitry is further configured to set a transmission timing of the second transmission cycle after an end timing of the first transmission cycle.

5. The dual-frequency fish finder of claim 1, wherein:
the processing circuitry is further configured to set a transmission timing of the first transmission cycle after an end timing of the second transmission cycle.

6. The dual-frequency fish finder of claim 1, wherein:
the first transmission cycle is one of a plurality of first transmission cycles, and
the processing circuitry is further configured to define a first interval between the transmission timing of the first frequency signal and the transmission timing of the second frequency signal that differs between each of the plurality of first transmission cycles.

7. The dual-frequency fish finder of claim 1, wherein:
the second transmission cycle is one of a plurality of second transmission cycles, and
the processing circuitry is further configured to define a second interval between the transmission timing of the second frequency signal and the transmission timing of the first frequency signal that differs between each of the plurality of second transmission cycles.

8. The dual-frequency fish finder of claim 1, wherein:
the processing circuitry is further configured to generate echo data indicating an echo intensity for each depth based on a reception signal of a transmission wave.

9. The dual-frequency fish finder of claim 8, wherein:
when the echo intensity of the echo data is mapped to a coordinate region having depth and time as axes, the processing circuitry is further configured to execute interference noise reduction processing for reducing the echo intensity of an interference wave based on the echo intensities at coordinate positions temporally adjacent to each other at a same depth for each of the first frequency and the second frequency.

10. The dual-frequency fish finder of claim 9, wherein:
the processing circuitry is further configured to generate a respective echo image based on the echo intensity for one screen of each of the first frequency and the second frequency to which the interference noise reduction processing is applied.

11. A dual-frequency transmission method, comprising:
transmitting a first frequency signal during a reception period of a second frequency signal in a second transmission cycle between a transmission timing of the second frequency signal and an end timing of a reception period of the first frequency signal; and
transmitting the second frequency signal, having a different frequency from the first frequency signal, during a reception period of the first frequency signal in a first transmission cycle between a transmission timing of the first frequency signal and an end timing of a reception period of the second frequency signal.

12. A non-transitory computer-readable medium having stored thereon computer-executable instructions which, when executed by a computer of a dual-frequency fish finder, cause the computer of the dual-frequency fish finder to:
transmit a first frequency signal during a reception period of a second frequency signal in a second transmission cycle between a transmission timing of the second frequency signal and an end timing of a reception period of the first frequency signal; and
transmit the second frequency signal, having a different frequency from the first frequency signal, during a reception period of the first frequency signal in a first transmission cycle between a transmission timing of the first frequency signal and an end timing of a reception period of the second frequency signal.

13. The dual-frequency fish finder of claim 2, wherein:
the processing circuitry is further configured to align the first transmission cycle and the second transmission cycle alternately.

14. The dual-frequency fish finder of claim 2, wherein:
the processing circuitry is further configured to set a transmission timing of the second transmission cycle after an ending timing of the first transmission cycle.

15. The dual-frequency fish finder of claim 3, wherein:
the processing circuitry is further configured to set a transmission timing of the second transmission cycle after an ending timing of the first transmission cycle.

16. The dual-frequency fish finder of claim 2, wherein:
the processing circuitry is further configured to set a transmission timing of the first transmission cycle after an ending timing of the second transmission cycle.

17. The dual-frequency fish finder of claim 3, wherein:
the processing circuitry is further configured to set a transmission timing of the first transmission cycle after an ending timing of the second transmission cycle.

18. The dual-frequency fish finder of claim 4, wherein:
the processing circuitry is further configured to set a transmission timing of the first transmission cycle after an ending timing of the second transmission cycle.

19. The dual-frequency fish finder of claim 2, wherein:
the first transmission cycle is one of a plurality of first transmission cycles, and
the processing circuitry is further configured to define a first interval between the transmission timing of the first frequency signal and the transmission timing of the second frequency signal that differs between each of the plurality of first transmission cycles.

20. The dual-frequency fish finder of claim 2, wherein:
the second transmission cycle is one of a plurality of second transmission cycles, and
the processing circuitry is further configured to define a second interval between the transmission timing of the second frequency signal and the transmission timing of the first frequency signal that differs between each of the plurality of second transmission cycles.
